(19) United States
(12) Patent Application Publication
(10) Pub. No.: US 2026/0328377 A1
(43) Pub. Date: Oct. 22, 2026

(54) A TRACK-LIGHTING SYSTEM

(71) Applicant: SIGNIFY HOLDING B.V., EINDHOVEN (NL)

(72) Inventors: TIES VAN BOMMEL, HORST (NL); ROBERT JACOB PET, WAALRE (NL)

(21) Appl. No.: 19/105,678

(22) PCT Filed: Aug. 9, 2023
(86) PCT No.: PCT/EP2023/072031

§ 371 Date: Feb. 21, 2025

(30) Foreign Application Priority Data
Aug. 22, 2022 (EP) 22191384.1

(51) Int. Cl. F21V 21/35

(52) U.S. Cl. CPC F21V 21/35

(57) ABSTRACT

The invention provides a track-lighting system comprising: (i) an elongated power track extending in a longitudinal direction along a longitudinal axis, wherein the elongated power track comprises: a tubular profile extending in said longitudinal direction, wherein the tubular profile comprises an inner surface, an outer surface, and a slot extending in said longitudinal direction, wherein the inner surface is accessible through said slot; an 5 inner track arranged on said inner surface and extending in said longitudinal direction; an outer track arranged on said outer surface and extending in said longitudinal direction; (ii) a lighting device; wherein the lighting device comprises an inner track-connector configured to connect the lighting device mechanically and electrically to said inner track; (iii) a panel; wherein the panel comprises an outer track-connector configured to connect the panel 10 mechanically to said outer track.

### FIELD OF THE INVENTION

The invention relates to a track-lighting system comprising an elongated power track, a lighting device, and a panel; wherein the lighting device and the panel are connected to said elongated power track. The invention also relates to such a power track and to such a panel.

### BACKGROUND OF THE INVENTION

Track lighting systems, in which track-lighting devices such as luminaires are fitted on tracks, are well known to provide great flexibility and adaptability, because the number of track-lighting devices and/or the positioning of track-lighting devices may be varied on the track. EP3428360A1 and/or CN213712781U disclose a track lighting system.

Track lighting systems are typically implemented in professional venues. The luminaires currently implemented in track-lighting systems are mostly point sources connected at single points on the track. A typical example of such a track-lighting system is for example a retail environment with multiple spotlights on a lighting track.

However, a current trend in the lighting business is to mount large-area luminaires to the track of a track-lighting system, such as for example a light panel. Another trend is that track-lighting systems are more and more implemented in domestic environments, such as within a living room and/or a kitchen.

As track-lighting systems become more popular and widespread, such as an increased attention to large-area luminaires (e.g. light panels) being connected to tracks, also in the domestic market, there is a clear need to find more safe and ergonomic solutions and improvements in connecting track-lighting devices to the track of a track lighting system.

### SUMMARY OF THE INVENTION

It is an object of the invention to provide an improved track-lighting system, which at least alleviates the problems and disadvantages mentioned above. Thereto, the invention provides, a track-lighting system comprising: (i) an elongated power track extending in a longitudinal direction along a longitudinal axis, wherein the elongated power track comprises: a tubular profile extending in said longitudinal direction, wherein the tubular profile comprises an inner surface, an outer surface, and a slot extending in said longitudinal direction, wherein the inner surface is accessible through said slot; an inner track arranged on said inner surface and extending in said longitudinal direction; an outer track arranged on said outer surface and extending in said longitudinal direction; (ii) a lighting device; wherein the lighting device comprises an inner track-connector configured to connect the lighting device mechanically and electrically to said inner track, and wherein said inner track is configured to connect said lighting device mechanically and electrically to said elongated power track; (iii) a panel; wherein the panel comprises an outer track-connector configured to connect the panel mechanically to said outer track, and wherein said outer track is configured to connect said panel mechanically and electrically to said elongated power track.

Hence, the track-lighting system according to the invention comprises an elongated power track. The track-lighting system further comprises a plurality of track-lighting devices connected to said elongated power track. Namely, the track-lighting system comprises a lighting device configured to be connected to said elongated power track, and a panel configured to be connected to said power track.

The elongated power track extends in a longitudinal direction along a longitudinal axis, The elongated power track comprises a tubular profile extending in said longitudinal direction. The tubular profile comprises an inner surface, an outer surface, and a slot extending in said longitudinal direction. The inner surface is accessible through said slot.

The elongated power track also comprises an inner track arranged on said inner surface and an outer track arranged on said outer surface, both extending in said longitudinal direction. The inner track is configured to connect the lighting device mechanically and electrically to said elongated power track. The outer track is configured to connect the panel mechanically (and optionally electrically) to said elongated power track.

More specifically, the lighting device comprises an inner track-connector configured connect the lighting device mechanically and electrically to said inner track, thereby to said elongated power track; and the panel comprises an outer track-connector configured to connect the panel mechanically (and optionally electrically) to said outer track, thereby to said elongated power track.

Since the lighting device is connected to the elongated power track via said inner track on the inner surface of the tubular profile, and since the panel is connected to the elongated power track via said outer track on the outer surface of the tubular profile, the track-lighting system according to the present invention advantageously enables alternative options for connecting different types of track-lighting devices to the elongated power track, and thereby balancing the mechanical loads on the elongated power track.

Since the panel is explicitly connected to the outer track arranged on the outer surface of the tubular profile, while the lighting device is connected electrically and mechanically to the inner track arranged on the inner surface of the tubular profile, the track-lighting system renders a more robust and safer connection, compared to a situation in which both the lighting device and the panel would have been connected to a same inner surface of the elongated power track.

The lighting device may be a point source lighting device. The lighting device may, in operation, emit lighting device light. The lighting device light may comprise a first lighting characteristic, such as for example a light intensity, a light (spatial) distribution, a light color, a light spectrum, etc. The lighting device may alternatively be phrased as luminaire throughout the application. The lighting device may be a semiconductor lighting device, such as a LED lighting device.

Throughout the application, the lighting device according to the invention, and the panel according to the invention, may be classified as track-lighting devices adapted to connected to a power track of a track-lighting system, such as the track-lighting system according to the present invention.

In an embodiment, the outer track-connector may be configured to connect the panel only mechanically to said outer track. This may be advantageous, as the elongated power track may not expose areas for electrical contact on the outer surface of the tubular profile.

However, in an alternative embodiment, the outer track-connector may be configured to connect the panel mechanically and electrically to said outer track. This may be advantageous, as the panel may be enabled to be powered by the outer track of the elongated power track.

As partly mentioned, the track-lighting device comprises a lighting device connected to said elongated power track and a panel connected to said power track. In an embodiment, the lighting device and the panel are located within a same plane perpendicular to the longitudinal axis when connected to the elongated power track. Hence, the lighting device and the panel may be connected at a same and/or overlapping location relative to the longitudinal axis.

In other words, the lighting device may be connected to the power track at a first position on said longitudinal axis; and the panel may be connected to the power track at a second position on said longitudinal axis; wherein the first position and the second position overlap (as projected) on said longitudinal axis.

Moreover, because the lighting device and the panel may be adapted to be connected at a same location (i.e. are located within a same plane), a customer may easily position a panel at the location of a lighting device. This advantageously enables a customer to replace the lighting function of the lighting device with a functionality of the panel, or to add the functionality of the panel to the lighting function of the lighting device at a respective location on the elongated power track. For example, when the panel is a lighting panel, to provide homogenous light over a larger surface instead of a point source of light emanating from the lighting device. For example, when the panel is an acoustic panel, to provide acoustic damping or reflection at the location of the lighting device. For example, when the panel is a ceiling tile, to hide the lighting device from view without needing to detach the lighting device. For example, when the panel is a light guide plate, to distribute the light of the lighting device more evenly over a larger surface, thereby rendering a totally new lighting effect (i.e. new lighting functionality) without the need to replace the lighting device itself.

The panel according to the invention may easily slide over the outer surface of the tubular profile, and associated outer track, so as to (at least partially) cover the lighting device and provide a panel functionality (i.e. the functionality the panel conveys) at the location of the lighting device. Similarly, the panel may subsequently slide back to uncover the lighting device again. The ability to render such control may be advantageous for track-lighting systems.

For example, a point source lighting device may remain connected at the elongated power track, and a lighting panel (being a surface lighting device) may be positioned near, around, or over the point source lighting device; so as to render a surface lighting function instead of a point source lighting function.

In an embodiment, the outer track may comprise a ridge protruding from the outer surface; and wherein the outer track-connector comprises a guide adapted to couple to the ridge of the outer track. In an alternative embodiment, the outer track may comprise a groove embedded in the outer surface; and wherein the outer track-connector comprises a protrusion adapted to couple to the groove of the outer track. Such a groove and a ridge may render common means, as at least partly known in the art, for mechanically connecting bodies (of devices) to each other in a safe and robust fashion.

The inner track-connector, and/or the outer track-connector, may for example utilize, for the connection between said track-lighting devices with the elongated power track, the concepts of one or more of: tight-fitting, snap-fitting, and click-fitting.

In an embodiment, the outer track may comprise a first outer track portion arranged along a first line on the outer surface; wherein the outer track may comprise a second outer track portion arranged along a second line on the outer surface; wherein the first line and the second line are arranged on the outer surface on opposing sides of the tubular profile.

Such an embodiment may be advantageous. Since the first outer track portion and the second outer track portion are arranged on the outer surface on opposing sides of the tubular profile, implying that said first and second outer track portions are separated by a distance therebetween, the tubular profile comprises two separate connection points (or: connection lines) at which the panel may be mechanically connected to said elongated power track. Consequently, having two separated connection points (or: connection lines), the tubular profile of the elongated power track advantageously provides an improved (spatial) distribution of the load when the panel is connected to said elongated power track, thereby rendering a more robust mechanical connection of the panel to the elongated power track.

Therefore, the outer track may for example carry larger loads more safely; such as the load of a panel, which is typically a larger dimensioned track-lighting device, because the dimensions of a panel are typically characterized by a large surface area with a relatively small thickness.

Another advantage is that such a two-sided connection caused by the first outer track portion and the second outer track portion provides more stability, particularly for panels connected to an elongated power track, compared to a traditional single point connection; because to the two-sided connection limits the number of degrees of freedom of the panel when the panel is connected in such a way to the elongated power track.

In a related embodiment, the first line and the second line may be arranged on the same plane; wherein said plane is perpendicular to the direction of gravity. Hence, since the load of the panel may act on the outer track in the gravitational direction, having the first outer track portion and the second outer track portion on a same plane perpendicular to the direction of gravity may render two separate connection points (or: connection lines) that can individually carry a load in the gravitational direction, while said outer track portion are not indifferent to each other in height relative to the gravitational direction. This may render a more robust connection.

In related aspects, the panel comprises an outer track-connector configured to connect the panel mechanically and electrically to said outer track, wherein the outer track is configured to connect the panel mechanically and electrically to said outer track, wherein the first outer track portion comprises an anode track, wherein the second outer track portion comprises a cathode track. Such an aspect may render electrical connection to the panel, and while the cathode and anode are on opposite sides of the tubular profile, electrical safety is rendered to a certain degree.

In an embodiment, the panel according to the invention may comprise at least one aperture; wherein each aperture of the at least one aperture is aligned with at least part of the slot and configured to enable the inner track-connector of the lighting device to access the inner track. Said access may thus be through the (aperture of the) panel. Hence, due to such an alignment, the inner track arranged on the inner surface of the tubular profile is accessible via the at least one aperture and the slot of the tubular profile. This enables a customer to connect a lighting device to the elongated power track via said slot and said aligned at least one aperture, without requiring the panel to be detached from the elongated power track.

In a related embodiment, the lighting device may comprise a body, wherein the body of the lighting device may at least partly be arranged within an aperture of the at least one aperture.

In a related embodiment, the lighting device may comprise a body and a connector part, wherein the body comprises a light source, wherein the body is arranged outside a first aperture of the at least one aperture, wherein the connector part comprises the inner track-connector, wherein the connector part is at least partly arranged within said first aperture.

In an embodiment, the lighting device is a spotlight. The lighting device may alternatively be any other semiconductor lighting device. For example, the lighting device may be a LED spotlight, a LED puck, A LED strip, a LED filament lamp, an incandescent lamp, a pendant lamp, etc. The lighting device may be a disinfection lighting device, wherein the lighting device emits lighting device light in operation, the lighting device light being ultraviolet light.

The panel may be embodied as various types of panels. Namely, in an embodiment, the panel may a light guide plate.

In a related embodiment, the panel may be a light guide plate, wherein the lighting device is in optical communication with the light guide plate; wherein the lighting device is configured to emit lighting device light; wherein the light guide plate comprises an incoupling surface, an outcoupling surface, and a light guide body; wherein the light guide plate is configured to receive said lighting device light at the incoupling surface, to convey said lighting device light via the light guide body to the outcoupling surface, and to couple said lighting device light out of the outcoupling surface.

In embodiments, the light guide plate may couple said lighting device light out of the outcoupling surface as light guide plate light. The light guide plate light may comprise a second lighting characteristic. As mentioned before, the lighting device light may comprise a first lighting characteristic. The first lighting characteristic and the second lighting characteristic may for example be a light intensity, a light (spatial) distribution, a light color, a light spectrum, etc. In an embodiment, the first lighting characteristic is different to the second lighting characteristic. Namely, the light guide plate may be configured to adapt the first lighting characteristic of the lighting device light to the second lighting characteristic of the light guide plate light.

For example, the first lighting characteristic may be a non-homogenous light distribution, whereas the second lighting characteristic may be a homogenous light distribution. For example, the first lighting characteristic may be a first light spectrum, whereas the second lighting characteristic may be a second light spectrum. For example, the first lighting characteristic may be a collimated beam, whereas the second lighting characteristic may be a diffuse beam.

Hence, the light guide plate comprises an incoupling surface. The light guide plate is configured to receive said lighting device light at said incoupling surface. The lighting device light may thereby comprise said first lighting characteristic. For example, a collimated beam of light. The (in-coupled) lighting device light may be conveyed through the light guide body of the light guide plate. The light guide plate, and/or the outcoupling surface of the light guide plate in particular, may optionally comprise light outcoupling structures to change a lighting characteristic of the lighting device light. Said light outcoupling structures may for example be arranged on the outcoupling surface at varying density, so as to render a homogenous outcoupling over the outcoupling surface. For example, said outcoupling structures may be phosphorous elements converting lighting device light comprising a first spectrum into the outcoupled lighting device light, or in other words the light guide plate light, into a different second spectrum.

In a different embodiment, the panel may be an acoustic panel. Such an acoustic panel may provide acoustic damping or acoustic reflection at the elongated power track, thereby rendering an additional function in addition to the lighting device also connected to said elongated power track. Such solutions may be advantageous, for example, in office settings where multiple people work and generate noise. Such acoustic plates in combination with said lighting device according to the invention may also be utilized to demarcate acoustic areas/zones with lighting.

In a related embodiment, the acoustic panel may comprise a panel material, wherein the panel material comprises a foam and/or a fibrous material.

In a related embodiment, the acoustic panel may at least partly be transparent for visible light. Such an embodiment may render a synergy between the lighting device and the acoustic panel, wherein the acoustic panel may serve as a lightguide or a diffuser for the lighting device, that is also connected to the elongated power track.

In related embodiments, the acoustic panel may comprise optical fibers, wherein the optical fibers are configured to convey lighting device light (emitted in operation by the lighting device) and to damp acoustic signals.

In different embodiments, the panel may be one of: a light guide plate, an optical reflector, a heating panel, such as an infrared panel, a (false) ceiling panel.

In a different embodiment, the panel may be a lighting panel. More specifically, in a related embodiment, the lighting panel may comprise a solid-state light source, a reflector, a diffusor, and a lightguide in optical communication with said solid-state light source and arranged between the reflector and the diffuser; or the lighting panel may comprise a light mixing chamber and a solid-state light source arranged within said light mixing chamber.

The elongated power track may be mounted to a mounting surface, such as a wall or a ceiling. Hence, the elongated power track may comprise mounting means for mounting the elongated power track to a mounting surface. For example, in an embodiment, the outer surface of the tubular profile may comprise a mounting means for mounting the elongated power track to a mounting surface. For example, in an embodiment, at least part of the outer surface of the tubular profile may be configured to mount the elongated power track to a mounting surface. The surface may be mounted (or: installed) to the mounting surface via known mounting techniques.

In an embodiment, the tubular profile may be a tubular profile with a U-shape. Hence, in other words, the tubular profile may be a U-shaped elongated profile, or a U-profile. Alternatively, the tubular profile may be a square tubular profile or a circular tubular profile, wherein the slot is arranged at a ventral side of such tubular profiles.

In aspects, said tubular profile may be characterized by a cavity, a base portion, a first leg portion, and a second leg portion; wherein the cavity is enclosed by the base portion, the first leg portion and the second leg portion and having an open side; wherein the inner surface of the tubular profile is constituted by said cavity, wherein the first leg portion and second leg portion are substantially parallel to each other and are connected by said base portion, such that the tubular profile has a substantially U-shaped cross-section extending in the longitudinal direction of the longitudinal axis.

In embodiments, the panel may be at least one panel, wherein the at least one panel covers at least 80% of the elongated power track, wherein each panel of the at least one panel abuts a neighboring panel of the at least one panel. Such an embodiment may be advantageous, as the panel may hide the elongated power track substantially from view.

It is further an object of the invention to provide an improved panel according to the invention. Thereto, the invention provides a lighting panel adapted to be connected to a track-lighting system according to the invention, wherein the lighting panel comprises: an outer track-connector configured to connect the panel mechanically to an outer track of said track-lighting system; a solid-state light source for emitting lighting panel light; an aperture; wherein, when connected to said track-lighting system, the aperture is aligned with at least part of a slot of said track-lighting system, and wherein the aperture is configured to enable a lighting device to access an inner track of said track-lighting system. Thereby, advantages and/or embodiments applying to the track-lighting system according to the invention may mutatis mutandis apply to said panel according to the invention.

In other words, in aspects, the invention may thus provide a lighting panel adapted to be connected to an elongated power track of a track-lighting system, wherein the elongated power track comprises a tubular profile extending in said longitudinal direction, wherein the tubular profile comprises an inner surface, an outer surface, and a slot extending in said longitudinal direction, wherein the inner surface is accessible through said slot; wherein the lighting panel comprises an outer track-connector configured to connect to an outer track arranged on said outer surface of the elongated power track; wherein the lighting panel comprises an aperture, wherein the aperture is aligned with at least part of said slot and configured to enable access to said inner surface.

It is further an object of the invention to provide an improved power track according to the invention. Thereto, the invention provides an elongated power track for a track-lighting system, wherein the elongated power track extends in a longitudinal direction along a longitudinal axis, wherein the elongated power track comprises: a tubular profile extending in said longitudinal direction, wherein the tubular profile comprises an inner surface, an outer surface, and a slot extending in said longitudinal direction, wherein the inner surface is accessible through said slot; an inner track arranged on said inner surface and extending in said longitudinal direction; an outer track arranged on said outer surface and extending in said longitudinal direction; wherein the inner track is configured to connect a lighting device to the elongated power track, wherein the outer track is configured to connect a panel to the elongated power track. Thereby, advantages and/or embodiments applying to the track-lighting system according to the invention may mutatis mutandis apply to said elongated power track according to the invention.

### BRIEF DESCRIPTION OF THE DRAWINGS

The invention will now be further elucidated by means of the schematic non-limiting drawings:

FIG. 1A and FIG. 1B depict schematically an embodiment of a track-lighting system according to the invention, wherein FIG. 1A is a side-view and FIG. 1B is a cross-sectional view;

FIG. 2A and FIG. 2B depict schematically an embodiment of a track-lighting system according to the invention, wherein FIG. 2A is a side-view and FIG. 2B is a cross-sectional view;

FIG. 3 depicts schematically an embodiment of a lighting panel according to the invention.

### DETAILED DESCRIPTION OF THE EMBODIMENTS

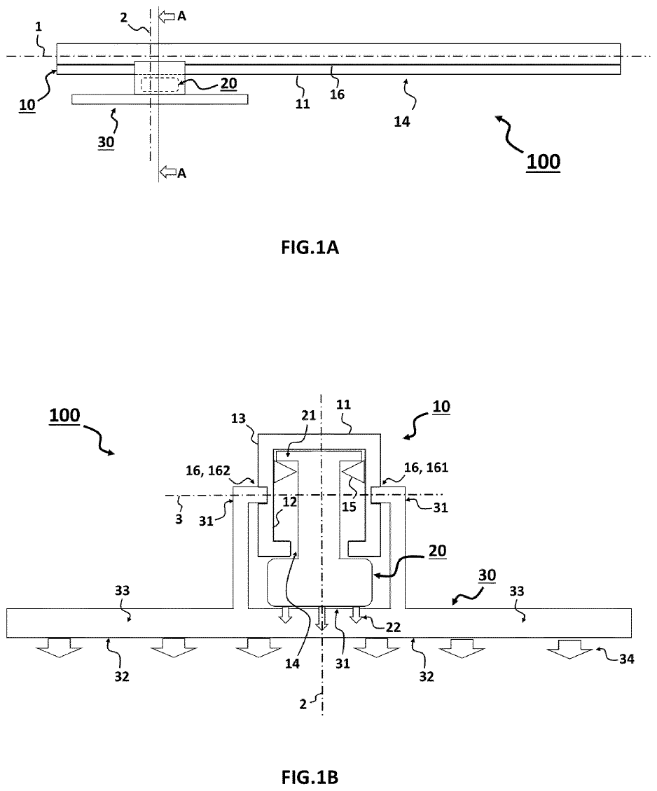

FIGS. 1A and 1B depict schematically, by non-limiting example, an embodiment of a track-lighting system 100 according to the invention. FIG. 1A depicts a side-view of said track-lighting system 100. FIG. 1B depicts a cross-sectional view of said track-lighting system 100 taken at line AA depicted in FIG. 1A.

The track-lighting system 100 comprises an elongated power track 10. The track-lighting system 100 also comprises a plurality of track-lighting devices 20, 30 connected to said elongated power track 10. Namely, according to the invention, the track-lighting system 100 comprises a lighting device 20 connected to said elongated power track 10, and a panel 30 connected to said elongated power track 10.

Referring to FIG. 1A and FIG. 1B, the elongated power track 10 extends in a longitudinal direction along a longitudinal axis 1. The lighting device 20 is located at a particular position along the longitudinal axis 1. The panel 30 is located at the same position along the longitudinal axis 1. Hence, the lighting device 20 and the panel 30 are located within a same plane 2 perpendicular to the longitudinal axis 1. The lighting device 20 and the panel 30 may overlap when connected to said elongated power track 10.

Referring to FIG. 1A and FIG. 1B, the elongated power track 10 comprises a tubular profile 11 extending in said longitudinal direction. The tubular profile 11 comprises an inner surface 12, an outer surface 13, and a slot 14 extending in said longitudinal direction 1. The inner surface 12 is accessible through said slot 14.

The tubular profile is depicted as a square cross-sectional shape having said slot. However, the tubular profile may alternatively be any other poly gonal cross-sectional shape having said slot, or a circular cross sectional shape having said slot.

The tubular profile 11 comprises an inner track 15 arranged on said inner surface 12. The inner track 15 extends also in said longitudinal direction 1. The inner track 15 is configured to connect the lighting device 20 mechanically and electrically to the elongated power track 10.

The lighting device 20 comprises an inner track-connector 21. The inner track-connector 21 connects the lighting device 20 mechanically and electrically to said inner track 15, and thereby to said elongated power track 10. The lighting device 20 is thereby mounted to the inner track 15 and the elongated power track 10 via said slot 14.

In aspects, the inner track may for example consist of an anode track and a cathode track. The inner track may for example comprise common mechanical means for coupling the lighting device to the elongated power track. The inner track may thereby confine the lighting device within the tubular profile of elongated power track, for example, with only a degree of freedom remaining to move the lighting device in the longitudinal direction along the longitudinal axis, and/or to rotate along a centerline that is perpendicular to the longitudinal axis and that is passing though the slot.

The tubular profile 11 further comprises an outer track 16 arranged on said outer surface 13. The outer track 16 extends also in said longitudinal direction 1. The outer track 15 is configured to connect the panel 30 mechanically to the (tubular profile of the) elongated power track 10. Alternatively, in optional embodiments, the outer track may also be configured to connect the panel 30 mechanically and electrically to the outer track. The outer track may for example consist of an anode track and a cathode track.

More specifically, still referring to FIG. 1A and FIG. 1B, in the present embodiment, the outer track 16 comprises a groove embedded in the outer surface 13 of the tubular profile 11.

The panel 30 comprises an outer track-connector 31. The outer track-connector 31 connects the panel 30 mechanically (and optionally electrically) to said outer track 16, and thereby to said elongated power track 10. The outer-track connecter 31 thereby comprises a protrusion adapted to couple to said groove of the outer track 16.

More specifically, still referring to FIG. 1A and FIG. 1B, the outer track 16 also comprises a first outer track portion 161 arranged along a first line (not explicitly depicted or referred to) on the outer surface 13. The outer track 16 also comprises a second outer track portion 161 arranged along a second line (not explicitly depicted or referred to) on the outer surface 13. The first line and the second line are arranged on the outer surface 13 on opposing sides of the tubular profile 11. In the present embodiment, by non-limiting example, the first line and the second line are arranged on a same plane 3, and said plane is 3 is perpendicular to the direction of gravity.

Alternatively, said plane does not need to be perpendicular to gravity, and can (for example for wall-mounted power tracks) be parallel to the direction of gravity; or under an angle relative to the gravitational direction. Yet alternatively, said first line and said second line may be arranged on opposing sides of the tubular profile, but not necessarily be on the same plane. Yet alternatively, said groove may be a ridge protruding from the outer surface.

In yet further aspects, the outer track may additionally be configured to electrically connect the panel to the elongated power track. The first outer track portion may thereby comprise an anode track and the second outer track portion may comprise an cathode track.

Since the lighting device 20 is connected to the elongated power track 10 via said inner track 15 on the inner surface 12 of the tubular profile 11, and since the panel 30 is connected to the elongated power track 10 via said first outer track portion 161 and said second outer track portion 162 on the outer surface 13 of the tubular profile 11, the track-lighting system 100 according to the present invention advantageously enables alternative options for connecting the panel 30 and the lighting device 20 to the elongated power track 10, and thereby balancing the mechanical loads on the elongated power track 10.

Since the panel 30 is explicitly connected to the outer track 16 arranged on the outer surface 13 of the tubular profile 11, namely via said first outer track portion 161 and said second outer track portion 162, while the lighting device 20 is connected electrically and mechanically to the inner track 15 arranged on the inner surface 12 of the tubular profile 11, the track-lighting system 10 renders a more robust and safer connection, compared to a situation in which both the lighting device 20 and the panel would have been connected to a same inner surface 12 of the elongated power track 10.

Even further, since the first outer track portion 161 and the second outer track portion 162 are arranged on the outer surface 13 on opposing sides of the tubular profile 11, the first outer track portion 161 and second outer track portions 162 are separated by a distance spanning between the opposing sides of the tubular profile 11 and over the plane 3. Moreover, the first outer track portion 161 and second outer track portion 162 provide the tubular profile 11 with two separate connection points, or connection lines, at which the panel 30 may be mechanically connected to said elongated power track 10. Consequently, the tubular profile 11 of the elongated power track 10 advantageously provides an improved (spatial) distribution of the load when the panel 30 is connected to said elongated power track 10, thereby rendering a more robust mechanical connection of the panel 30 to the elongated power track 10.

Therefore, the outer track 16 may for example carry larger loads of the panel 30 more safely, as the load may be distributed over the first outer track portion 161 and the second outer track portion 162. Another advantage is that such a two-sided connection caused by the first outer track portion 161 and the second outer track portion 162 provides more stability, particularly for the panel 30 connected to an elongated power track 10, compared to a traditional single point connection.

Still referring to the embodiment depicted in FIG. 1A and FIG. 1B, as mentioned before, the lighting device 20 and the panel 30 are located within a same plane 2 perpendicular to the longitudinal axis, when connected to the elongated power track 10.

Here, the panel 30 is a light guide plate. Alternatively, in different embodiments, the panel may for example be an acoustic panel, a lighting panel, a heating panel. The light guide plate 30 comprises an incoupling surface 31, an outcoupling surface 32, and a light guide body 33. The lighting device 20 is configured to emit lighting device light 22 in operation. The lighting device 20 is in optical communication with the light guide plate 30. The light guide plate 30 is configured to receive said lighting device light 22 at the incoupling surface 31. Hence, the lighting device light 22 is coupled into the light guide body 33 at the incoupling surface 31. The lighting device light 22 comprises a first lighting characteristic. The light guide body 33 of the light guide plate 30 conveys said lighting device light 22. The lighting device light 22 is coupled out at the outcoupling surface 32. The outcoupled lighting device light may be defined as light guide plate light. The light guide plate light may comprise a second lighting characteristic.

The lighting device light 22 may thus comprise a first lighting characteristic when coupled at the incoupling surface 31 and comprise a second lighting characteristic when coupled out at the outcoupling surface 32, said first lighting characteristic being a first light distribution and said second lighting characteristic being a second light distribution, wherein the first light distribution is different from the second light distribution, for example, the second light distribution being more homogenous or less collimated. For example, the first lighting characteristic may be a directional light, while the second lighting characteristic may be diffuse light.

Hence, the light guide plate 30 is configured to convey said lighting device light 22 via the light guide body 33 to the outcoupling surface 32. This renders a surface of light 34. The surface of light may be more homogenous light distribution compared to a point source distribution of the lighting device. The panel may serve as a diffusor.

Alternatively, or additionally, the light guide plate may comprise outcoupling structures to render a uniform distribution of light coupled out. The light guide plate may alternatively, or additionally, comprise phosphorus elements to convert a first light spectrum of the lighting device light to a second light spectrum.

Hence, in the present invention, the panel 30 may not only be more robustly connected to the elongated power track 10, while the lighting device 20 is also connected to the elongated power track 10 at an overlapping location (relative to the longitudinal axis), but the panel 30 will also provide a function additional to the function of the lighting device 20, namely, to transform a point source of light connected to the power track 10 to a surface of light.

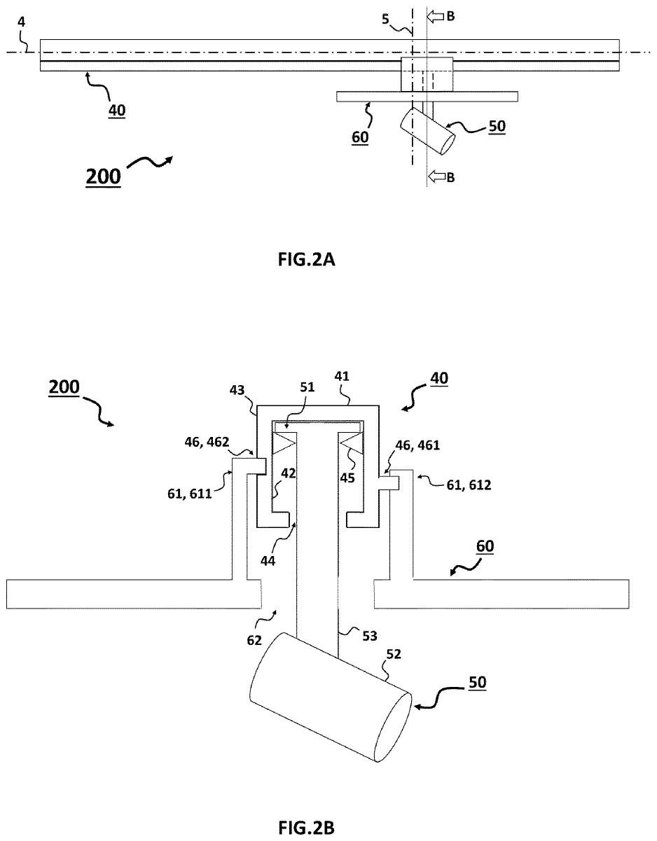

FIGS. 2A and 2B depict schematically, by non-limiting example, an embodiment of a track-lighting system 200 according to the invention. FIG. 2A depicts a side-view of said track-lighting system 200. FIG. 2B depicts a cross-sectional view of said track-lighting system 200 taken at line BB depicted in FIG. 2A.

The track-lighting system 200 comprises an elongated power track 40. The track-lighting system 200 also comprises a plurality of track-lighting devices 50, 60 connected to said elongated power track 40. Namely, according to the invention, the track-lighting system 200 comprises a lighting device 50 connected to said elongated power track 40, and a panel 60 connected to said elongated power track 40.

Referring to FIG. 2A and FIG. 2B, the elongated power track 40 extends in a longitudinal direction along a longitudinal axis 4. The elongated power track 40 comprises a tubular profile 41 extending in said longitudinal direction. The tubular profile 41 comprises an inner surface 42, an outer surface 43, and a slot 44 extending in said longitudinal direction 4. The inner surface 42 is accessible through said slot 44.

The tubular profile 41 also comprises an inner track 45 arranged on said inner surface 42. The inner track 45 extends also in said longitudinal direction 4. The inner track 45 is thereby configured to connect the lighting device 50 mechanically and electrically to the elongated power track 40.

In aspects, the inner track may for example consist of an anode track and a cathode track. The inner track may for example comprise common mechanical means for coupling the lighting device to the elongated power track. The inner track may thereby confine the lighting device within the elongated power track, for example, with a degree of freedom to move in the longitudinal direction along the longitudinal axis, and/or with a degree of freedom to rotate along a centerline perpendicular to the longitudinal axis that is passing thought the slot.

The tubular profile 41 also comprises an outer track 46 arranged on said outer surface 43. The outer track 46 extends also in said longitudinal direction 4. The outer track 46 is thereby configured to connect the panel 60 mechanically and electrically to the elongated power track 40. Alternatively, in embodiments, the outer track may also be configured to connect the panel only mechanically to the outer track.

More specifically, still referring to FIG. 2A and FIG. 2B, in the present embodiment, the outer track 46 comprises a first outer track portion 461 arranged along a first on the outer surface 43 and a second outer track portion 462 arranged along a second line on the outer surface 43. Both are aligned along the longitudinal axis 4. The first line and the second line are arranged on the outer surface 43 on opposing sides of the tubular profile 41. The first outer track portion 461 is a ridge protruding from the outer surface 43. The second outer track portion 462 is a groove embedded in the outer surface 43. Here, the first outer track portion 461 comprises an anode track. Here, the second outer track portion 462 comprises a cathode track.

Still referring to FIG. 2A and FIG. 2B, the lighting device 50 comprises an inner track-connector 51. The inner track-connector 51 connects the lighting device 50 mechanically and electrically to said inner track 45, and thereby to said elongated power track 50. The lighting device 50 is thereby mounted to the inner track 45 and the elongated power track 40 via said slot 44.

Still referring to FIG. 2A and FIG. 2B, the panel 60 comprises an outer track-connector 61. The outer track-connector 61 connects the panel 60 mechanically and electrically to said outer track 46, and thereby to said elongated power track 40. More specifically, the outer track-connector comprises a guide 612 adapted to couple to the ridge of the first outer track portion 461, and comprises a protrusion 611 adapted to couple to the groove of the second outer track portion 462.

Since the lighting device 50 is connected to the elongated power track 40 via said inner track 45 on the inner surface 42 of the tubular profile 41, and since the panel 60 is connected to the elongated power track 40 via said first outer track portion 461 and said second outer track portion 462 on the outer surface 43 of the tubular profile 41, the track-lighting system 200 according to the present invention advantageously enables alternative options for connecting the panel 60 and the lighting device 50 to the elongated power track 40, and thereby balancing the mechanical loads on the elongated power track 40.

Since the panel 60 is explicitly connected to the outer track 46 arranged on the outer surface 43 of the tubular profile 41, namely via said first outer track portion 461 and said second outer track portion 462, while the lighting device 50 is connected electrically and mechanically to the inner track 45 arranged on the inner surface 42 of the tubular profile 41, the track-lighting system 200 renders a more robust and safer connection, compared to a situation in which both the lighting device and the panel would have been connected to a same inner surface of the elongated power track.

Even further, since the first outer track portion 461 and the second outer track portion 462 are arranged on the outer surface 43 on opposing sides of the tubular profile 41, the first and second outer track portions 461, 462 provide the tubular profile 41 with two separate connection points, or connection lines, at which the panel 60 may be mechanically (and electrically) connected to said elongated power track 40. Consequently, the tubular profile 41 of the elongated power track 40 advantageously provides an improved (spatial) distribution of the load when the panel 60 is connected to said elongated power track 40, thereby rendering a more robust mechanical connection of the panel 60 to the elongated power track 40. Such a two-sided connection also provides more stability, particularly for the panel 60 connected to an elongated power track 40, compared to a traditional single point connection

Still referring to the embodiment depicted in FIG. 2A and FIG. 2B, the lighting device 50 and the panel 60 are located within a same plane 5 perpendicular to the longitudinal axis 4, when connected to the elongated power track 40.

Here, the lighting device is a spotlight 50. The lighting device may alternatively be any other lighting device, such as a point source lighting device. The lighting device 50, namely said spotlight 50, comprises a body 52 and a connector part 53. The body 52 may be referred to as a head, or lighting module, or lighting body. The inner track-connector 51 is arranged on said connector part 53.

Here, the panel is lighting panel 60. Alternatively, in different embodiments, the panel may for example be an acoustic panel. The panel 60 (i.e. the lighting panel) comprises an aperture 62. The aperture 62 is aligned with at least part of the slot 44. Therefore, the aperture 62 enables the inner track-connector of the lighting device 50 (i.e. the spotlight) to access the inner track 65 through the panel 60 and thereby enable the lighting device 50 to be connected to the elongated power track 40 through said panel 60.

The connector part 53 may for example be considered a rod that fits through the aperture 62 and the slot 44. Here, the connector part 53 is arranged within said aperture 62, while the body 52 is arranged outside said aperture 62. In alternative embodiments, the body of the lighting device may at least partly be mounted within said aperture.

Still referring to the embodiment depicted in FIG. 2A and FIG. 2B, the lighting panel 60 may emit lighting panel light, whereas the lighting device may emit lighting device light. The lighting panel light and the lighting device light may for example comprise a different lighting characteristic, such as for example a different spatial light distribution, a different light color, a different homogeneity of light, a different intensity of light, a different color temperature of light, etc.

In aspects, the lighting panel may comprise a solid-state light source, a reflector, a diffusor, and a lightguide in optical communication with said solid-state light source and arranged between the reflector and the diffuser. Yet alternatively, the lighting panel may comprise a light mixing chamber and a solid-state light source arranged within said light mixing chamber.

In an embodiment, not depicted, a track-lighting system is provided that is the same as the track-lighting system as depicted in FIG. 1A-B, or the same as the track-lighting system as depicted in FIG. 1A-B, but wherein the panel is an acoustic panel. The acoustic panel may provide an additional function in addition to the lighting device also connected to said elongated power track. The acoustic panel may thereby comprise a panel material, wherein the panel material comprises a foam and/or a fibrous material. The acoustic panel may also be at least partly transparent for visible light. The acoustic panel can thereby work as a diffuser, or as a light guide, or as a filter. Such an embodiment may render a synergy between the lighting device and the acoustic panel on the same elongated power track. In related embodiments, the acoustic panel may comprise optical fibers, wherein the optical fibers are configured to convey lighting device light (emitted in operation by the lighting device) and to damp acoustic signals.

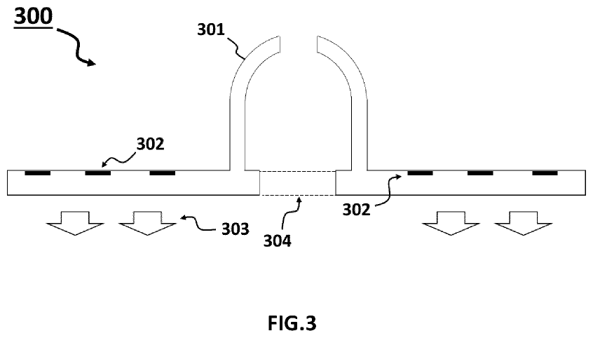

FIG. 3 depicts schematically an embodiment of a lighting panel 300 according to the invention. The lighting panel 300 is adapted to be connected to a track-lighting system according to the invention. The lighting panel 300 comprises an outer track-connector 301 configured to connect the panel 300 mechanically to an outer track of a track-lighting system. The lighting panel 300 comprises a solid-state light source 302, here a plurality of LED light sources, for emitting lighting panel light 303. The lighting panel 300 comprises an aperture 304. Furthermore, when said lighting panel 300 is connected to a track-lighting system, the aperture 304 is aligned with at least part of a slot of said track-lighting system. The aperture is configured to enable a lighting device (such as for example a spotlight) to access an inner track of said track-lighting system.

1. A track-lighting system comprising:
(i) an elongated power track extending in a longitudinal direction along a longitudinal axis, wherein the elongated power track comprises:
a tubular profile extending in said longitudinal direction, wherein the tubular profile comprises an inner surface, an outer surface, and a slot extending in said longitudinal direction, wherein the inner surface is accessible through said slot;
an inner track arranged on said inner surface and extending in said longitudinal direction;
an outer track arranged on said outer surface and extending in said longitudinal direction;
(ii) a lighting device;
wherein the lighting device comprises an inner track-connector configured to connect the lighting device mechanically and electrically to said inner track, and wherein said inner track is configured to connect said lighting device mechanically and electrically to said elongated power track;
(iii) a panel;
wherein the panel comprises an outer track-connector configured to connect the panel mechanically to said outer track, and wherein said outer track is configured to connect said panel mechanically and electrically to said elongated power track.

2. The track-lighting system according to claim 1,
wherein the outer track-connector is configured to connect the panel mechanically and electrically to said outer track.

3. The track-lighting system according to claim 1,
wherein the lighting device and the panel are located within a same plane perpendicular to the longitudinal axis when connected to the elongated power track.

4. The track-lighting system according to claim 1,
wherein the outer track comprises a ridge protruding from the outer surface; and wherein the outer track-connector comprises a guide adapted to couple to the ridge of the outer track; or
wherein the outer track comprises a groove embedded in the outer surface; and wherein the outer track-connector comprises a protrusion adapted to couple to the groove of the outer track.

5. The track-lighting system according to claim 1, wherein the outer track comprises a first outer track portion arranged along a first line on the outer surface;
wherein the outer track comprises a second outer track portion arranged along a second line on the outer surface;
wherein the first line and the second line are arranged on the outer surface on opposing sides of the tubular profile.

6. The track-lighting system according to claim 5, wherein the first line and the second line are arranged on the same plane;
wherein said plane is perpendicular to the direction of gravity.

7. The track-lighting system according to claim 1, wherein the panel comprises at least one aperture;
wherein each aperture of the at least one aperture is aligned with at least part of the slot and configured to enable the inner track-connector of the lighting device to access the inner track.

8. The track-lighting system according to claim 7, wherein the lighting device comprises a body, wherein the body of the lighting device is at least partly arranged within an aperture of the at least one aperture.

9. The track-lighting system according to claim 1, wherein the lighting device is a spotlight.

10. The track-lighting system according to claim 1, wherein the panel is a light guide plate, wherein the lighting device is in optical communication with the light guide plate;
wherein the lighting device is configured to emit lighting device light;
wherein the light guide plate comprises an incoupling surface, an outcoupling surface, and a light guide body; wherein the light guide plate is configured to receive said lighting device light at the incoupling surface, to convey said lighting device light via the light guide body to the outcoupling surface, and to couple said lighting device light out of the outcoupling surface.

11. The track-lighting system according to claim 1, wherein the panel is an acoustic panel.

12. The track-lighting system according to claim 11, wherein the acoustic panel is at least partly transparent for visible light.

13. The track-lighting system according to claim 1, wherein the panel is a lighting panel.

14. The track-lighting system according to claim 13,
wherein the lighting panel comprises a solid-state light source, a reflector, a diffusor, and a lightguide in optical communication with said solid-state light source and arranged between the reflector and the diffuser; or
wherein the lighting panel comprises a light mixing chamber and a solid-state light source arranged within said light mixing chamber.

15. A lighting panel adapted to be connected to a track-lighting system according to claim 1, wherein the lighting panel comprises:
an outer track-connector configured to connect the panel mechanically to an outer track of said track-lighting system;
a solid-state light source for emitting lighting panel light;
an aperture;
wherein, when connected to said track-lighting system, the aperture is aligned with at least part of a slot of said track-lighting system, and wherein the aperture is configured to enable a lighting device to access an inner track of said track-lighting system.
